(19) United States
(12) Patent Application Publication
(10) Pub. No.: US 2007/0140335 A1
(43) Pub. Date: Jun. 21, 2007

(54) Method of encoding video signals

(75) Inventors: Piotr Wilinski, Eindhoven (NL); Christiaan Varekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 10/577,107

(22) PCT Filed: Oct. 14, 2004
(86) PCT No.: PCT/IB04/03384

§ 371 Date: Apr. 25, 2006

(30) Foreign Application Priority Data
Oct. 31, 2003 (EP) 03300190.0

(51) Int. Cl. H04N 7/12

(52) U.S. Cl. 375/240.08; 375/240.26

(57) ABSTRACT

There is provided a method of encoding a video signal comprising a sequence of images to generate corresponding encoded video data. The method including the steps of: (a) analyzing the images to identify one or more image segments therein; (b) identifying those of said one or more segments which are substantially not of a spatially stochastic nature and encoding them in a deterministic manner to generate first encoded intermediate data; (c) identifying those of said one or more segments which are of a substantially spatially stochastic nature and encoding them by way of one or more corresponding stochastic model parameters to generate second encoded intermediate data; and (d) merging the first and second intermediate data to generate the encoded video data.

### FIELD OF THE INVENTION

The present invention relates to methods of encoding video signals; in particular, but not exclusively, the present invention relates to a method of encoding video signals utilizing image segmentation to sub-divide video images into corresponding segments and applying stochastic texture models to a selected sub-group of the segments to generate encoded and/or compressed video data. Moreover, the invention also relates to methods of decoding video signals encoded according to the invention. Furthermore, the invention also relates to encoders, decoders, and encoding/decoding systems operating according to one or more of the aforementioned methods. Additionally, the invention also relates to data carriers bearing encoded data generated by the aforementioned method of encoding video data according to the invention.

### BACKGROUND TO THE INVENTION

Methods of encoding and correspondingly decoding image information have been known for many years. Such methods are of significance in DVD, mobile telephone digital image transmission, digital cable television and digital satellite television. In consequence, there exists a range of encoding and corresponding decoding techniques, some of which have become internationally recognised standards such as MPEG-2.

During recent years, a new International Telecommunications Union (ITU) standard, namely the ITU-T standard, has emerged, the new standard being known as H.26L. This new standard has now become widely recognized as being capable of providing superior coding efficiency in comparison to contemporary established corresponding standards. In recent evaluations, the new H.26L standard has demonstrated that it is capable of achieving a comparable signal-to-noise ratio (S/N) for approaching 50% less encoded data bits in comparison to earlier contemporary established image encoding standards.

Although benefits provided by the new standard H.26L generally decrease in proportion to image picture size, namely a number of image pixels therein, a potential for the new standard H.26L being deployed in a broad range of applications is undoubted. Such potential has been recognized through formation of a Joint Video Team (JVT) which has been endowed with a responsibility to evolve the standard H.26L to be adopted by the ITU-T as a new joint ITU-T/MPEG standard. The new standard is expected to be formally approved in 2003 as ITU-T H.264 or ISO/IEC MPEG-4 AVC; “AVC” here is an abbreviation for “Advance Video Coding”. Presently, the H.264 standard is also being considered by other standardization bodies, for example “the DVB and DVD Forum”. Moreover, both software and hardware implementations of H.264 encoders and decoders are also becoming available.

Other forms of video encoding and decoding are also known. For example, in a United States patent no. U.S. Pat. No. 5,917,609, there is described a hybrid waveform and model-based image signal encoder and corresponding decoder. In the encoder and corresponding decoder, an original image signal is waveform-encoded and decoded so as to approximate the waveform of the original signal as closely as possible after compression. In order to compensate its loss, a noise component of the signal, namely a signal component which is lost by the waveform encoding, is model-based encoded and separately transmitted or stored. In the decoder, the noise is regenerated and added to the waveform-decoded image signal. The encoder and decoder elucidated in this patent no. U.S. Pat. No. 5,917,609 are especially pertinent to compression of medical X-ray angiographic images where loss of noise leads a cardiologist or radiologist to conclude that corresponding images are distorted. However, the encoder and corresponding decoder described are to be regarded as specialist implementations not necessarily complying with any established or emerging image encoding and corresponding decoding standards.

A goal of video compression is to diminish the quantity of bits which are allocated to represent given visual information. Using transforms such as cosine transforms, fractals or wavelets, it is conventionally found possible to identify new more efficient approaches in which video signals can be represented. However, the inventors have appreciated that there are two ways of representing video signals, namely a deterministic way and a stochastic way. A texture in an image is susceptible to being represented stochastically and may be implemented by finding a most resembling noise model. For some regions of video images, human visual perception does not concentrate on precise pattern detail which fills-in the regions; visual perception is rather more directed towards certain non-deterministic and directional characteristics of textures. Conventional stochastic description of textures, for example as in medical image processing applications and in satellite image processing applications as in meteorology, has concentrated on the compression of images of clear stochastic nature, for example cloud formations.

The inventors have appreciated that contemporary encoding schemes, for example the H.264 standard, the MPEG-2 standard, the MPEG-4 standard, as well as new video compression schemes such as structured and/or layered video are not capable of yielding as much data compression as is technically feasible. In particular, the inventors have appreciated that some regions of images in video data are susceptible to being described by stochastic texture models in encoded video data, especially those parts of the image having a spatial noise-like appearance. Moreover, the inventors have appreciated that motion compensation and depth profiles are preferably utilized for ensuring that artificially-generated textures during subsequent decoding of the encoded video data are convincingly rendered in decoded video data. Furthermore, the inventors have appreciated that their approach is susceptible to being applied in the context of segmentation based video encoding.

Thus, the inventors have addressed a problem of enhancing data compression arising during video data encoding whilst maintaining video quality when subsequently decoding such encoded and compressed video data.

### SUMMARY OF THE INVENTION

A first object of the present invention is to provide a method of encoding video signals which is capable of providing an enhanced degree of data compression in encoded video data corresponding to the video signals.

A second object of the present invention is to provide a method of modelling spatially stochastic image texture in video data.

A third object of the present invention is to provide a method of decoding video data which has been encoded using parameters to describe spatially stochastic image content therein.

A fourth object of the present invention is to provide an encoder for encoding input video signals to generate corresponding encoded video data with a greater degree of compression.

A fifth object of the present invention is to provide a decoder for decoding video data which has been encoded from video signals by way of stochastic texture modelling.

According to a first aspect of the present invention, there is a method of encoding a video signal comprising a sequence of images to generate corresponding encoded video data, the method including the steps of:
(a) analyzing the images to identify one or more image segments therein;
(b) identifying those of said one or more segments which are substantially not of a spatially stochastic nature and encoding them in a deterministic manner to generate first encoded intermediate data;
(c) identifying those of said one or more segments which are of a substantially spatially stochastic nature and encoding them by way of one or more corresponding stochastic model parameters to generate second encoded intermediate data; and
(d) merging the first and second intermediate data to generate the encoded video data.

The invention is of advantage in that the method of encoding is capable of providing an enhanced degree of data compression.

Preferably, in step (c) of the method, the one or more segments of a substantially spatially stochastic nature are encoded using first or second encoding routines depending upon a characteristic of temporal motion occurring within said one or more segments, said first routine being adapted for processing segments in which motion occurs and said second routine being adapted for processing segments which are substantially temporally static.

Distinguishing regions corresponding to stochastic detail with considerable temporal activity from those with relatively less temporal activity is capable of enabling a higher degree of encoding optimization to be achieved with associated enhanced data compression.

Preferably, the method is further distinguished in that:
(e) in step (b), said one or more segments substantially not of a spatially stochastic nature are deterministically encoded using I-frames, B-frames and/or P-frames, said I-frames including information deterministically describing texture components of said one or more segments, and said B-frames and/or P-frames including information describing temporal motion of said one or more segments; and
(f) in step (c), said one or more segments of a substantially stochastic nature comprising texture components are encoded using said model parameters, B-frames and/or P-frames, said model parameters describing texture of said one or more segments and said B-frames and/or P-frames including information describing temporal motion of said one of more segments.

In the foregoing, I-frames are to be construed to correspond to data fields corresponding to a description of spatial layout of at least part of one or more images. Moreover, B-frames and P-frames are to be construed to correspond to data fields describing temporal motion and depth of modulation. Thus, the present invention is capable of providing an enhanced degree of compression because I-frames corresponding to stochastic image detail are susceptible to being represented in more compact form by stochastic model parameters instead of these I-frames needing to include a complete conventional description of its associated image detail, for instance by transform coding.

According to a second aspect of the present invention, there is provided a data carrier bearing encoded video data generated using a method according to the first aspect of the present invention.

According to a third aspect of the present invention, there is provided a method of decoding encoded video data to regenerate corresponding decoded video signals, the method including the steps of:
(a) receiving the encoded video data and identifying one or more segments therein;
(b) identifying those of said one or more segments substantially not of a spatially stochastic nature and decoding them in a deterministic manner to generate first decoded intermediate data;
(c) identifying those of said one or more segments substantially of a spatially stochastic nature and decoding them by way of one or more stochastic models driven by model parameters included in said encoded video data input to generate second decoded intermediate data; and
(d) merging the first and second intermediate data to generate said decoded video signals.

Preferably, the method is distinguished in that in step (c) the one or more segments of a substantially spatially stochastic nature are decoded using first or second decoding routines depending upon a characteristic of temporal motion occurring within said one or more segments, said first routine being adapted for processing segments in which motion occurs and said second routine being adapted for processing segments which are substantially temporally static.

Preferably, the method is further distinguished in that:
(e) in step (b), said one or more segments substantially not of a spatially stochastic nature are deterministically decoded using I-frames, B-frames and/or P-frames, said I-frames including information deterministically describing texture components of said one or more segments, and said B-frames and/or P-frames including information describing temporal motion of said one or more segments; and
(f) in step (c), said one or more segments of a substantially stochastic nature comprising texture components are decoded using said model parameters, B-frames and/or P-frames, said model parameters describing texture of said one or more segments and said B-frames and/or P-frames including information describing temporal motion of said one of more segments.

According to fourth aspect of the present invention, there is provided an encoder for encoding a video signal comprising a sequence of images to generate corresponding encoded video data, the encoder including:
(a) analyzing means for analyzing the images to identify one or more image segments therein;
(b) first identifying means for identifying those of said one or more segments which are substantially not of a spatially stochastic nature and encoding them in a deterministic manner to generate first encoded intermediate data;
(c) second identifying means for identifying those of said one or more segments which are of a substantially spatially stochastic nature and encoding them by way of one or more corresponding stochastic model parameters to generate second encoded intermediate data; and
(d) data merging means for merging the first and second intermediate data to generate the encoded video data.

Preferably, in the encoder, the second identifying means is operable to encode the one or more segments of a substantially spatially stochastic nature using first or second encoding routines depending upon a characteristic of temporal motion occurring within said one or more segments, said first routine being adapted for processing segments in which motion occurs and said second routine being adapted for processing segments which are substantially temporally static.

Preferably, in the encoder:
(e) said first identifying means is operable to deterministically encode said one or more segments substantially not of a spatially stochastic nature using I-frames, B-frames and/or P-frames, said I-frames including information deterministically describing texture components of said one or more segments, and said B-frames and/or P-frames including information describing temporal motion of said one or more segments; and
(f) said second identifying means is operable to encode said one or more segments of a substantially stochastic nature comprising texture components using said model parameters, B-frames and/or P-frames, said model parameters describing texture of said one or more segments and said B-frames and/or P-frames including information describing temporal motion of said one of more segments.

Preferably, the encoder is implemented using at least one of electronic hardware and software executable on computing hardware.

According to a fifth aspect of the present invention, there is provided a decoder for decoding encoded video data to regenerate corresponding decoded video signals, the decoder including:
(a) analyzing means for receiving the encoded video data and identifying one or more segments therein;
(b) first identifying means for identifying those of said one or more segments substantially not of a spatially stochastic nature and decoding them in a deterministic manner to generate first decoded intermediate data;
(c) second identifying means for identifying those of said one or more segments substantially of a spatially stochastic nature and decoding them by way of one or more stochastic models driven by model parameters included in said encoded video data input to generate second decoded intermediate data; and
(d) merging means for merging the first and second intermediate data to generate said decoded video signals.

Preferably, the decoder is distinguished in that it is arranged to decode the one or more segments of a substantially spatially stochastic nature using first or second decoding routines depending upon a characteristic of temporal motion occurring within said one or more segments, said first routine being adapted for processing segments in which motion occurs and said second routine being adapted for processing segments which are substantially temporally static.

Preferably, the decoder is further distinguished in that:
(e) said first identifying means is operable to decode deterministically said one or more segments substantially not of a spatially stochastic nature using I-frames, B-frames and/or P-frames, said I-frames including information deterministically describing texture components of said one or more segments, and said B-frames and/or P-frames including information describing temporal motion of said one or more segments; and
(f) said second identifying means is operable to decode said one or more segments of a substantially stochastic nature comprising texture components using said model parameters, B-frames and/or P-frames, said model parameters describing texture of said one or more segments and said B-frames and/or P-frames including information describing temporal motion of said one of more segments.

Preferably, the decoder is implemented using at least one of electronic hardware and software executable on computing hardware.

It will be appreciated that features of the invention are capable of being combined in any combination without departing from the scope of the invention.

### DESCRIPTION OF THE DIAGRAMS

Embodiments of the invention will now be described, by way of example only, with reference to the accompanying drawings wherein:

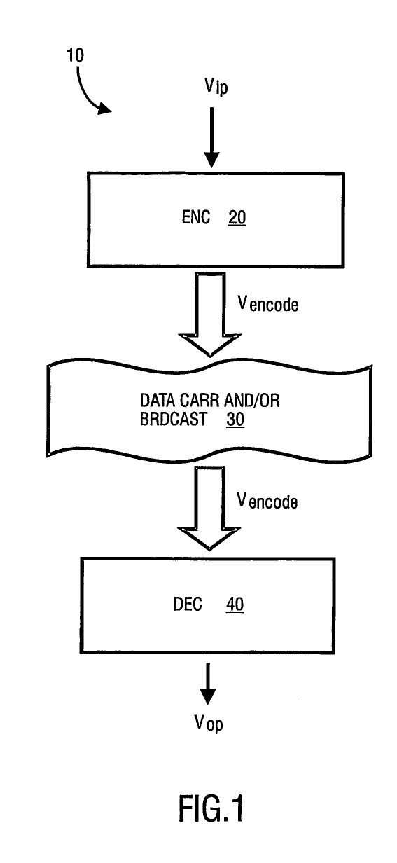

FIG. 1 is a schematic diagram of a video process including a first step of encoding input video signals to generate corresponding encoded video data, a second step of recording the encoded video data on a data carrier and/or broadcasting the encoded video data, and a third step of decoding the encoded video data to reconstruct a version of the input video signals;

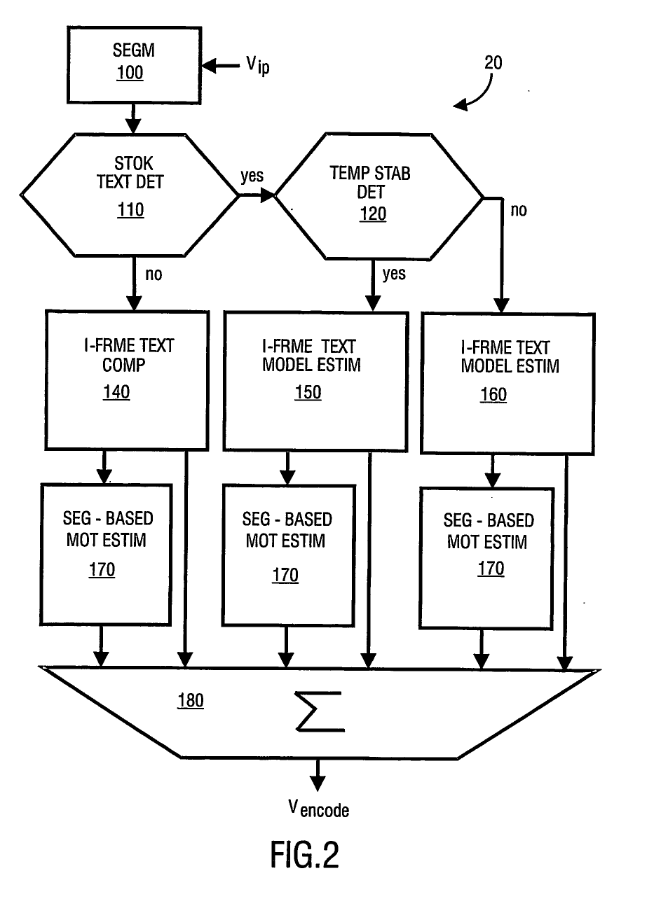

FIG. 2 is a schematic diagram of the first step depicted in FIG. 1 wherein input video signals Vᵢₚ are encoded to generate corresponding encoded video data V_{encode}; and

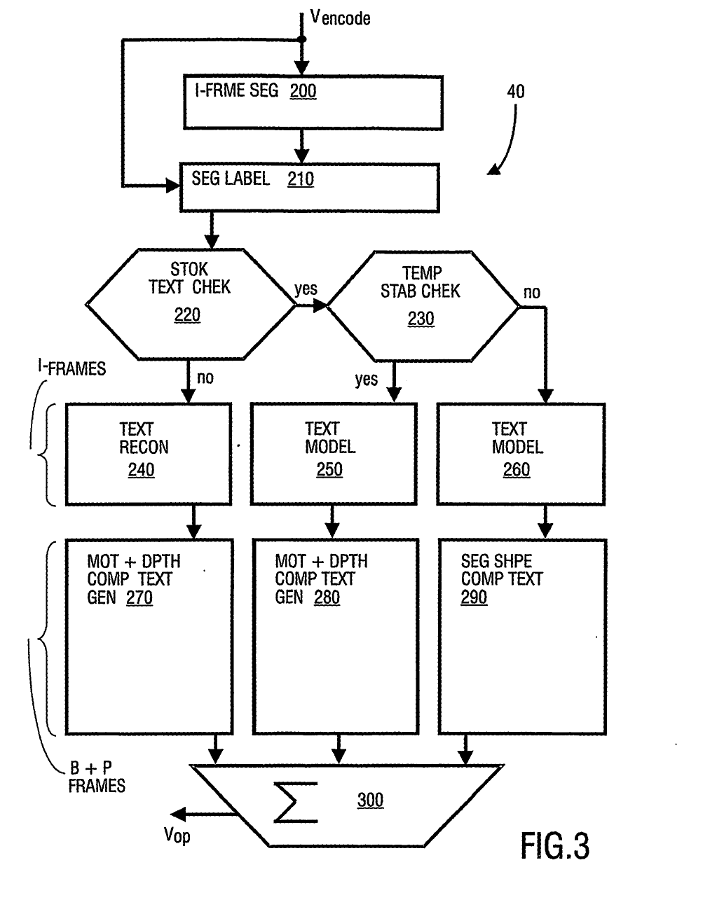

FIG. 3 is a schematic diagram of the third step depicted in FIG. 1 wherein the encoded video data is decoded to generate output video signals Vₒₚ corresponding to a reconstruction of the input video signals Vᵢₚ.

### DESCRIPTION OF EMBODIMENTS OF THE INVENTION

Referring to FIG. 1, there is shown a video process indicated generally by 10. The process 10 includes a first step of encoding input video signals Vᵢₚ in an encoder (ENC) 20 to generate corresponding encoded video data V_{encode}, a second step of storing the encoded video data V_{encode} on a data carrier (DATA CARR AND/OR BRDCAST) 30 and/or transmitting the encoded video data V_{encode} via a suitable broadcasting network 30, and a third step of decoding in a decoder (DEC) 40 the broadcast and/or stored video data V_{encode} to reconstruct output video signals Vₒₚ corresponding to the input video signals for subsequent viewing. The input video signals Vᵢₚ preferably comply with contemporarily known video standards and comprise a temporal sequence of pictures or images. In the encoder 20, the images are represented by way of frames wherein there are I-frames, B-frames and P-frames. The designation of such frames is well known in the contemporary art of video encoding.

In operation, the input video signals Vᵢₚ are provided to the encoder 20 which applies a segmentation process to images present in the input signals Vᵢₚ. The segmentation process subdivides the images into spatially segmented regions to which are then applied a first analysis to determine whether or not they include stochastic texture. Moreover, the segmentation process is also arranged to perform a second analysis for determining whether or not the segmented regions identified as having stochastic texture are temporally stable. Encoding functions applied to the input signals Vᵢₚ are then selected according to results from the first and second analyses to generate the encoded output video data V_{encode}. The output video data V_{encode} is then recorded on the data carrier 30, for example at least one of:
(a) solid state memory, for example EEPROM and/or SRAM;
(b) optic storage media such as CD-ROM, DVD, proprietary Blu-Ray media; and
(c) magnetic disc recording media, for example transferable magnetic hard disc.

Additionally, or alternatively, the encoded video data V_{encode} is susceptible to being broadcast, for example via terrestrial wireless, via satellite transmission, via data networks such as the Internet, and via established telephone networks.

Subsequently, the encoder video data V_{encode} is then at least one of received from the broadcasting network 30 and read from the data carrier 30 and thereafter input to the decoder 40 which then reconstructs a copy of the input video signals Vᵢₚ as the output video signals Vₒₚ. In decoding the encoded video data V_{encode}, the decoder 40 applies an I-frame segmentation function to determine parameter labels applied by the encoder 20 to segments, then determines from these labels whether or not stochastic texture is present. Where the presence of stochastic texture is indicated for one or more of the segments by way of their associated labels, the decoder 40 further determines whether or not the stochastic texture is temporally stable. Depending upon the nature of the segments, for example their stochastic texture and/or temporal stability, the decoder 40 passes therein the segments via appropriate functions to reconstruct a copy of the input video signal Vᵢₚ to output as the output video signals Vₒₚ.

Thus, in devising the video process 10, the inventors have evolved a method of compressing video signals based on a frame segmentation technique for which certain segment regions are described by parameters in corresponding compressed encoded data, such certain regions having content of a spatially stochastic nature and being susceptible to being reconstructed using stochastic models in the decoder 40 driven by the parameters. In order to further assist such reconstruction, motion compensation and depth profile information are also beneficially utilized.

The inventors have appreciated that, in the context of video compression, some parts of video texture are susceptible to being modelled in a statistical manner. Such statistical modelling is practicable as an approach to gain enhanced compression because of a manner in which the human brain interprets parts of images by concentrating primary on the shape of their borders rather than concentrating on detail within inside regions of the parts. Thus, in the compressed encoded video data V_{encode} generated by the process 10, parts of an image susceptible to being stochastically modelled are represented in the video data as border information together with parameters concisely describing content within the border, the parameters being susceptible to driving a texture generator in the decoder 40.

However, the quality of a decoded image is determined by several parameters and, from experience, one of the most important parameters is temporal stability, such stability also being pertinent to the stability of parts of images including texture. Thus, in the encoded video data V_{encode}, texture of a spatial statistical nature is also described in temporal terms to enable a time-stable statistical impression to be provided in the decoded output video signals Vₒₚ.

Thus, the inventors have appreciated a contemporary problem of achieving enhanced compression in encoded video data. Having appreciated the stochastic nature of image texture, a subsidiary problem of identifying appropriate parameters to employ in encoded video data with regard to representing such texture has been considered.

These problems are capable of being addressed in the present invention by utilizing texture depth and motion information at the decoder 40 to regenerate such texture. Conventionally, parameters have only been employed in the context of deterministic texture generation, for example static background texture as in video games and such like.

A contemporary video stream, for example as present in the encoder 20, is divided into I-frames, B-frames and P-frames. I-frames are conventionally compressed in encoded video data in a manner which allows for the reconstruction of detailed texture during subsequent decoding of the video data. Moreover, B-frames and P-frames are reconstructed during decoding by using motion vectors and residue information. The present invention is distinguished from conventional video signal processing methods in that some textures in I-frames do not need to be transmitted, but only their statistical model by way of model parameters. Moreover, in the present invention, at least one of motion information and depth information is computed for B-frames and P-frames. In the decoder 40, a random texture is generated during decoding of the encoded video data V_{encode}, the texture being generated for the I-frames and motion and/or depth information being generated consistently for use with B-frames and P-frames. By a combination of textural modelling in conjunction with appropriate utilization of motion and/or depth information, data compression achieved in the video data V_{encode} is greater in the encoder 20 in comparison to aforementioned contemporary encoders without substantial perceptible decrease in decoded video quality.

The process 10 is susceptible to being used in the context of conventional and/or new video compression schemes. Conventional schemes include one or more of MPEG-2, MPEG4 and H.264 standards whereas new video compression schemes include structured video and layered video formats. Moreover, the present invention is applicable to block-based and segment-based video codecs.

In order to further elucidate the present invention, embodiments of the invention will be described with reference to FIGS. 2 and 3.

In FIG. 2, the encoder 20 is illustrated in more detail. The encoder 20 includes a segment function (SEGM) 100 for receiving the input video signals Vᵢₚ. Output from the segment function 100 is coupled to a stochastic texture detection function (STOK TEXT DET) 110 having “yes” and “no” outputs; these outputs are indicative in operation of whether or not image segments include spatially stochastic texture detail. The encoder 20 further includes a texture temporal stability detection function (TEMP STAB DET) 120 for receiving information from the texture detection function 110. The “no” output from the texture detection function 110 is coupled to an I-frame texture compression function (I-FRME TEXT COMP) 140 which in turn couples directly to a data summing function 180 and indirectly via a first segment-based motion estimation function (SEG-BASED MOT ESTIM) 170 to the summing function 180. Similarly, a “yes” output from the stability detection function 120 is coupled to an I-frame texture model estimation function (I-FRME TEXT MODEL ESTIM) 150 whose outputs are coupled directly to the summing function 180 and indirectly via a second segment-based motion estimation function (SEG-BASED MOT ESTM) 170 to the summing function 180. Likewise, a “no” output from the stability detection function 120 is coupled to an I-frame texture model estimation function (I-FRME TEXT MODEL ESTIM) 160 whose outputs are coupled directly to the summing function 180 and indirectly via a third segment-based motion estimation function (SEG-BASED MOT ESTIM) 170 to the summing function 180. The summing function 180 includes a data output from outputting encoded video data V_{encode} corresponding to a combination of data received at the summing function 180. The encoder 20 is capable of being implemented in software executing on computing hardware and/or as customized electronic hardware, for example as an application specific integrated circuit (ASIC).

In operation, the encoder 20 receives at its input the input video signals Vᵢₚ. The signals are stored, and digitized when required from analogue to digital format, in memory associated with the segment function 100 thereby giving rise to stored video images therein. The function 100 analyses video images in its memory and identifies segments within the images, for example sub-regions of the images, which have a predefined degree of similarity. Next, the function 100 outputs data indicative of the segments to the texture detection function 110; beneficially, the texture detection function 110 has access to the memory associated with the segment function 100.

The texture detection function 110 analyses each of the image segments presented to it to determine whether or not their textural content is susceptible to being described by stochastic modelling parameters.

When the texture detection function 110 identifies that stochastic modelling is not suitable, it passes segment information to the texture compressing function 140 and its associated first motion estimation function 170 to generate compressed video data corresponding to the segment in a more conventional deterministic manner for receiving at the summing function 180. The first motion estimation function 170 coupled to the texture compression function 140 is operable to provide data suitable for B-frames and P-frames whereas the texture compression function 140 is operable to directly produce I-frame type data.

Conversely, when the texture detection function 110 identifies that stochastic modelling is suitable, it passes segment information to the temporal stability detection function 120. This function 120 analyses temporal stability of segments referred to it. When a segment is found to be temporally stable, for example in a tranquil scene filmed by a stationary camera where the scene includes an expanse of mottled wall susceptible to stochastic modelling, the stability detection function 120 passes the segment information to the texture model estimation function 150 which generates model parameters for the identified segment which are passed directly to the summing function 180 and via the second motion estimation function 170 which generates parameters for corresponding B-frames and P-frames regarding motion in the identified segment. Alternatively, when the stability detection function 120 identifies that a segment is not temporally sufficiently stable, the stability detection function 120 passes the segment information to the texture model estimation function 160 which generates model parameters for the identified segment which are passed directly to the summing function 180 and via the third motion estimation function 170 which generates parameters for corresponding B-frames and P-frames regarding motion in the identified segment. Preferably, the texture model estimation functions 150, 160 are optimized for coping with relatively static and relatively rapidly changing images respectively. As described in the foregoing, the summing function 180 assimilates outputs from the functions 140, 150, 160, 170 together and then outputs the corresponding compressed encoded video data V_{encode}.

Thus, in operation, the encoder 20 is arranged such that some textures in the I-frames do not have to be transmitted, only their equivalent stochastic/statistical model. However, motion and/or depth information is computed for corresponding B-frames and P-frames.

In order to further describe operation of the encoder 20, a manner in which it processes various types of image features will now be described.

Not all regions in a video image are susceptible to being described in a statistical manner. Three types of regions are often encountered in video images:
(a) Type 1: Regions including spatially non-statistical texture. In the encoder 20, such type 1 regions are compressed in a deterministic manner into I-frames, B-frames and P-frames of the encoded output video data V_{encode}. For the corresponding I-frames, the deterministic texture is transmitted. Moreover, associated motion information is transmitted in B-frames and P-frames. Depth data allowing an accurate ordering of regions at the decoder side is preferably transmitted or recomputed at the level of the decoder 40;
(b) Type 2: Regions including spatially statistical but non-stationary texture. Examples of such regions comprise waves, mist or fire. For type 2 regions, the encoder 20 is operable to transmit a statistical model. Due to a random temporal motion of such regions, no motion information is used in subsequent texture generation processes, for example arising in the decoder 40. For every video frame, another representation of the texture will be generated from the statistical model during decoding. However, the shape of the regions, namely information spatially describing their peripheral edges, is motion compensated in the encoder output video data V_{encode};
(c) Type 3: Regions which are relatively temporally stable and include texture. Examples of such regions are grass, sand and details of forest. For this type of region, a statistical model is transmitted, for example an ARMA model, with temporal motion and/or depth information being transmitted in B-frames and P-frames in the encoded output video data V_{encode}. Information encoded into the I-frames, B-frames and P-frames is utilized in the decoder 40 to generate texture for the regions in a time consistent manner.

Thus, the encoder 20 is operable to determine whether image texture is to be compressed in a conventional manner, for example by way of DCT, wavelets or similar, or by way of a parameterized model as described for the present invention.

Referring next to FIG. 3, there is shown component parts of the decoder 40 in greater detail. The decoder 40 is susceptible to being implemented as custom hardware and/or by software executing on computer hardware. The decoder 40 comprises an I-frame segmenting function (I-FRME SEG) 200, a segment labelling function (SEG LABEL) 210, a stochastic texture checking function (STOK TEXT CHEK) 220 and a temporal stability checking function (TEMP STAB CHEK) 230. Moreover, the decoder 40 further comprises a texture reconstructing function (TEXT RECON) 240, and first and second texture modelling functions (TEXT MODEL) 250, 260 respectively; these functions 240, 250, 260 are primarily concerned with I-frame information. Furthermore, the decoder 40 includes first and second motion and depth compensated texture generating functions (MOT+DPTH COMP TEXT GEN) 270, 280 respectively together with a segment shape compensated texture generating function (SEG SHPE COMP TEXT) 290; these functions 270, 280, 290 are primarily concerned with B-frame and P-frame information. Lastly, the decoder 40 includes a summing function 300 for combining outputs from the generating functions 270, 280, 290.

Interoperation of various functions of the decoder 40 will now be described.

The encoded video data V_{encode} input to the decoder 40 is coupled to an input of the segmenting function 200 and also to a control input of the segment labelling function 210 as illustrated. An output from the segmenting function 200 is also coupled to a data input of the segment labelling function 210. An output of the segment labelling function 210 is connected to an input of the texture checking function 220. Moreover, the texture checking function 220 comprises a first “no” output linked to a data input of the texture reconstruction function 240 and a “yes” output coupled to an input of the stability checking function 230. Furthermore, the stability checking function 230 includes a “yes” output coupled to the first texture generating function 250 and a corresponding “no” output coupled to the second texture generating function 260. Data outputs from the functions 240, 250, 260 are coupled to corresponding data inputs of the functions 270, 280, 290 as illustrated. Finally, data outputs from the functions 270, 280, 290 are coupled to summing inputs of the summing function 300, the summing function 300 also comprising a data output for providing the aforementioned decoded video output Vₒₚ.

In operation of the decoder 40, the encoded video data V_{encode} is passed to the segmenting function 200 which identifies image segments from the I-frames in the data V_{encode} and passes them to the labelling function 210 which labels the identified segments with appropriate associated parameters. Segment data output from the labelling function 210 passes to the texture checking function 220 which analyses the segments received thereat to determine whether or not they have associated therewith stochastic texture parameters indicating that stochastic modelling is intended. Where no indication for the use of stochastic texture modelling is found, namely an aforementioned Type-1 region, the segment data is passed to the reconstruction function 240 which decodes the segments referred thereto in a conventional deterministic manner to generate corresponding decoded I-frame data which is then passed to the generating function 270 where motion and depth information is added in a conventional manner to the decoded I-frame data.

When the checking function 220 identifies that the segments provided thereto are stochastic in nature, namely Type-2 and/or Type-3 regions, the function 220 forwards them to the stability checking function 230 which analyses to determine whether the forwarded segments are encoded to be relatively stable, namely aforementioned Type-3 regions, or subject to relatively greater degrees of temporal change, namely aforementioned Type-2 regions. When the segments are found by the checking function 230 to be Type-2 regions, it forwards them to the “yes” output and thereby to the first texture modelling function 250 and subsequently to the texture generating function 280. Conversely, when the segments are found by the checking function 230 to be Type-3 regions, the checking function 230 forwards them to the “no” output and thereby to the second texture modelling function 260 and subsequently to the compensated texture generating function 290. The summing function 300 is operable to receive outputs form the functions 270, 280, 290 and combine them to generate the decoded output video data Vₒₚ.

The generating functions 270, 280 are arranged to be optimized for performing motion and depth reconstruction of segments, whereas the texture generating function 290 is optimized for reconstructing relatively motionless segments of spatially stochastic nature as elucidated in the foregoing.

Thus, the decoder 40 effectively comprises three segment reconstruction channels, namely a first channel comprising the functions 240, 270, a second channel comprising the functions 250, 280, and a third channel comprising the functions 260, 290. The first, second and third channels are associated with the reconstruction of encoded segments corresponding to Type-1, Type-2 and Type-3 regions respectively.

It will be appreciated that embodiments of the present invention described in the foregoing are susceptible to being modified without departing from the scope of the invention.

In the foregoing, it will be appreciated that expressions such as “comprise”, “include”, “contain” and “comprise” are to be construed in a non-exclusive manner, namely other unspecified items or components are also susceptible to being present.

1. A method (20) of encoding a video signal comprising a sequence of images to generate corresponding encoded video data, the method including the steps of:
(a) analyzing (100) the images to identify one or more image segments therein;
(b) identifying (110) those of said one or more segments which are substantially not of a spatially stochastic nature and encoding them in a deterministic manner (140, 170) to generate first encoded intermediate data;
(c) identifying (110, 120) those of said one or more segments which are of a substantially spatially stochastic nature and encoding them (150, 160, 170, 180) by way of one or more corresponding stochastic model parameters to generate second encoded intermediate data; and
(d) merging (180) the first and second intermediate data to generate the encoded video data.

2. A method according to claim 1, wherein in step (c), the one or more segments of a substantially spatially stochastic nature are encoded using first or second encoding routines depending upon a characteristic of temporal motion occurring within said one or more segments, said first routine (150, 170) being adapted for processing segments in which motion occurs and said second routine (160, 170) being adapted for processing segments which are substantially temporally static.

3. A method according to claim 1, wherein:
(e) in step (b), said one or more segments substantially not of a spatially stochastic nature are deterministically encoded using I-frames, B-frames and/or P-frames, said I-frames including information deterministically describing texture components of said one or more segments, and said B-frames and/or P-frames including information describing temporal motion of said one or more segments; and
(f) in step (c), said one or more segments of a substantially stochastic nature comprising texture components are encoded using said model parameters, B-frames and/or P-frames, said model parameters describing texture of said one or more segments and said B-frames and/or P-frames including information describing temporal motion of said one of more segments.

4. A data carrier bearing encoded video data generated using a method according to claim 1.

5. A method of decoding encoded video data to regenerate corresponding decoded video signals, the method including the steps of:
(a) receiving the encoded video data and identifying one or more segments therein;
(b) identifying those of said one or more segments substantially not of a spatially stochastic nature and decoding them in a deterministic manner to generate first decoded intermediate data;
(c) identifying those of said one or more segments substantially of a spatially stochastic nature and decoding them by way of one or more stochastic models driven by model parameters included in said encoded video data input to generate second decoded intermediate data; and
(d) merging the first and second intermediate data to generate said decoded video signals.

6. A method according to claim 5, wherein in step (c) the one or more segments of a substantially spatially stochastic nature are decoded using first or second decoding routines depending upon a characteristic of temporal motion occurring within said one or more segments, said first routine being adapted for processing segments in which motion occurs and said second routine being adapted for processing segments which are substantially temporally static.

7. A method according to claim 5, wherein:
(e) in step (b), said one or more segments substantially not of a spatially stochastic nature are deterministically decoded using I-frames, B-frames and/or P-frames, said I-frames including information deterministically describing texture components of said one or more segments, and said B-frames and/or P-frames including information describing temporal motion of said one or more segments; and
(f) in step (c), said one or more segments of a substantially stochastic nature comprising texture components are decoded using said model parameters, B-frames and/or P-frames, said model parameters describing texture of said one or more segments and said B-frames and/or P-frames including information describing temporal motion of said one of more segments.

8. An encoder (20) for encoding a video signal comprising a sequence of images to generate corresponding encoded video data, the encoder (20) including:
(a) analyzing means for analyzing the images to identify one or more image segments therein;
(b) first identifying means (110) for identifying those of said one or more segments which are substantially not of a spatially stochastic nature and encoding them in a deterministic manner to generate first encoded intermediate data;
(c) second identifying means (120) for identifying those of said one or more segments which are of a substantially spatially stochastic nature and encoding them by way of one or more corresponding stochastic model parameters to generate second encoded intermediate data; and
(d) data merging means (180) for merging the first and second intermediate data to generate the encoded video data.

9. An encoder (20) according to claim 8, wherein the second identifying means is operable to encode the one or more segments of a substantially spatially stochastic nature using first or second encoding routines depending upon a characteristic of temporal motion occurring within said one or more segments, said first routine being adapted for processing segments in which motion occurs and said second routine being adapted for processing segments which are substantially temporally static.

10. An encoder (20) according to claim 8, wherein:
(e) said first identifying means is operable to deterministically encoded said one or more segments substantially not of a spatially stochastic nature using I-frames, B-frames and/or P-frames, said I-frames including information deterministically describing texture components of said one or more segments, and said B-frames and/or P-frames including information describing temporal motion of said one or more segments; and
(f) said second identifying means is operable to encode said one or more segments of a substantially stochastic nature comprising texture components using said model parameters, B-frames and/or P-frames, said model parameters describing texture of said one or more segments and said B-frames and/or P-frames including information describing temporal motion of said one of more segments.

11. An encoder (20) according to claim 8, implemented using at least one of electronic hardware and software executable on computing hardware.

12. A decoder (40) for decoding encoded video data to regenerate corresponding decoded video signals, the decoder including:
(a) analyzing means for receiving the encoded video data and identifying one or more segments therein;
(b) first identifying means for identifying those of said one or more segments substantially not of a spatially stochastic nature and decoding them in a deterministic manner to generate first decoded intermediate data;
(c) second identifying means for identifying those of said one or more segments substantially of a spatially stochastic nature and decoding them by way of one or more stochastic models driven by model parameters included in said encoded video data input to generate second decoded intermediate data; and
(d) merging means for merging the first and second intermediate data to generate said decoded video signals.

13. A decoder (40) according to claim 12, arranged to decode the one or more segments of a substantially spatially stochastic nature using first or second decoding routines depending upon a characteristic of temporal motion occurring within said one or more segments, said first routine being adapted for processing segments in which motion occurs and said second routine being adapted for processing segments which are substantially temporally static.

14. A decoder (40) according to claim 12, wherein:
(e) said first identifying means is operable to decode deterministically said one or more segments substantially not of a spatially stochastic nature using I-frames, B-frames and/or P-frames, said I-frames including information deterministically describing texture components of said one or more segments, and said B-frames and/or P-frames including information describing temporal motion of said one or more segments; and
(f) said second identifying means is operable to decode said one or more segments of a substantially stochastic nature comprising texture components using said model parameters, B-frames and/or P-frames, said model parameters describing texture of said one or more segments and said B-frames and/or P-frames including information describing temporal motion of said one of more segments.

15. A decoder (40) according to claim 12, implemented using at least one of electronic hardware and software executable on computing hardware.
